(19) United States
(12) Patent Application Publication
(10) Pub. No.: US 2007/0239893 A1
(43) Pub. Date: Oct. 11, 2007

(54) METHOD FOR ALLOCATING PORTS IN A COMMUNICATION NETWORK

(75) Inventor: KEITH CROWE, AUSTIN, TX (US)

Correspondence Address: AKERMAN SENTERFITT, P.O. BOX 3188, WEST PALM BEACH, FL, 33402-3188, US

(73) Assignee: SBC KNOWLEDGE VENTURES, L.P., RENO, NV (US)

(21) Appl. No.: 11/279,230

(22) Filed: Apr. 10, 2006

(51) Int. Cl. G06F 15/173; G06F 15/16

(52) U.S. Cl. 709/245; 709/238

(57) ABSTRACT

A system (100) and method (300) are disclosed for allocating ports in a communication network. A system that incorporates teachings of the present disclosure may include, for example, a communication device (102) having a controller that manages a transceiver coupled to a firewall networking element (104). The controller (206) can enable (316) a communication application operating therein according to port information supplied (314) by a port server (106) having port availability information corresponding to the firewall networking element. Additional embodiments are disclosed.

### FIELD OF THE DISCLOSURE

The present disclosure relates generally to networking techniques, and more specifically to a method for allocating ports in a communication network.

### BACKGROUND

Firewalls can be utilized in networking applications to prevent unauthorized traffic in private networks and can also be used for managing port allocations for communications involving Internet access, Voice over IP (VoIP), and video conferences, just to name a few. Often a communications application operating in a computing device such as a laptop computer will randomly select a port to initiate communications with an end device. If the port selected, however, is not one of the open ports on the firewall, communications will be blocked with no recourse unless the end user knows the available ports established by the firewall.

A need therefore arises for a method and apparatus that overcomes the aforementioned deficiency in the art.

### BRIEF DESCRIPTION OF THE DRAWINGS

FIG. 1 depicts an exemplary embodiment of a communication system;

FIG. 2 depicts an exemplary block diagram of a computing device operating in the communication system;

FIGS. 3-4 depict exemplary methods operating in the computing device and a port server; and

FIG. 5 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method for allocating ports in a communication network.

In a first embodiment of the present disclosure, a computer-readable storage medium in a computing device coupled to a firewall networking element that manages message exchanges with a communication system can have computer instructions for transmitting to a port server a request for port availability information corresponding to the firewall networking element, receiving port information from the port server corresponding to the firewall networking element, and enabling a communication application according to the port information supplied by the port server.

In a second embodiment of the present disclosure, a computer-readable storage medium in a port server coupled to one or more firewall networking elements by way of a communication system can have computer instructions for receiving port availability information from each of the one or more firewall networking elements, receiving from a computing device a request for port information corresponding to a select one of the one or more firewall networking elements, and retrieving the port information requested from the port availability information corresponding to the selected firewall networking element.

In a third embodiment of the present disclosure, a communication device can have a controller that manages a transceiver coupled to a firewall networking element. The controller can enable a communication application operating therein according to port information supplied by a port server having port availability information corresponding to the firewall networking element.

In a fourth embodiment of the present disclosure, a computer-readable storage medium operating in a computing device coupled to a firewall networking element that manages message exchanges with a communication system can have computer instructions for polling a communications device by way of the firewall networking element to determine which ports are available for communication in the communication system, storing port availability information determined from polling the communications device, detecting a communication application requiring one or more ports to communicate with another computing device in the communication system, and enabling the communication application according to the port availability information.

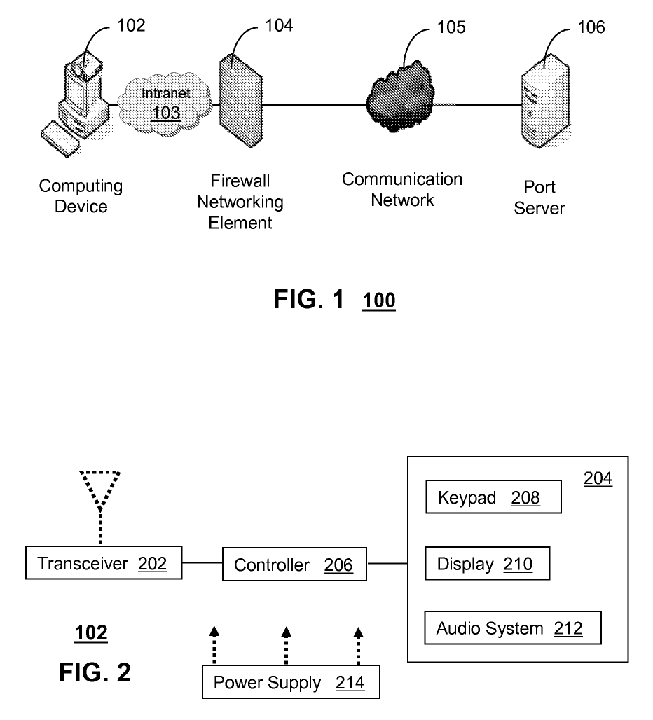

FIG. 1 depicts an exemplary embodiment of a communication system 100. The communication system 100 comprises a computing device 102 (such as a computer) coupled to a common firewall networking element (FNE)104 by way of an Intranet 103 that couples other computing devices to the FNE. The FNE 104 serves to manage traffic between the Intranet 103 and external communication networks such as the Internet 105 according to a corporate policy established by personnel managing said system. In the present illustration, the computing device (CD) 102 communicates with a port server (PS) 106 which serves as a repository of port information of the FNE 104 according to the present disclosure. The PS 106 can comprise any common computing technology such as a desktop computer or scalable server. Although shown external the FNE 104, the PS 106 can be located on the Intranet 103 without departing from the scope of the present disclosure.

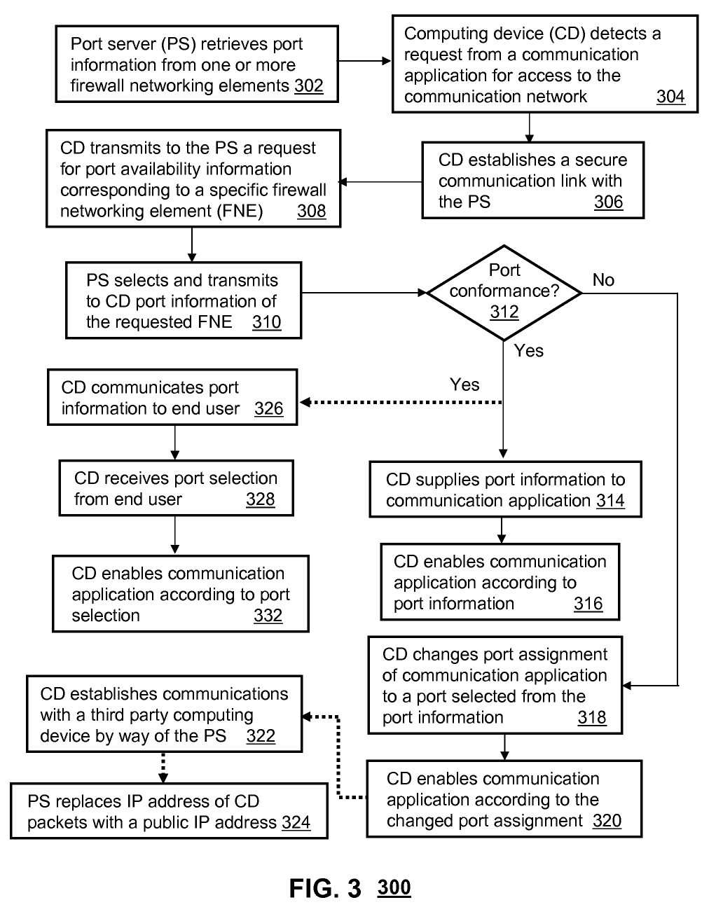

FIG. 2 depicts an exemplary embodiment of the CD 102. The CD 102 can comprise a wireline and/or wireless transceiver 202, a user interface (UI) 204, a power supply 214, and a controller 206 for managing operations of the foregoing components. The transceiver 202 can utilize common communication technologies to support singly or in combination any number of wireline or wireless access technologies including without limitation plain old telephone service (POTS), digital subscriber line (DSL), Ethernet, Bluetooth™, Wireless Fidelity (WiFi), Worldwide Interoperability for Microwave Access (WiMAX), Ultra Wide Band (UWB), software defined radio (SDR), and cellular access technologies such as CDMA-1X, W-CDMA/HSDPA, GSM/GPRS, TDMA/EDGE, and EVDO, just to name a few. SDR can be utilized for accessing public and private communication spectrum with any number of communication protocols that can be dynamically downloaded over-the-air to the CD 102. It should be noted also that next generation wireless access technologies can also be applied to the present disclosure.

The UI 204 can include a keypad 208 with depressible or touch sensitive keys and a navigation disk for manipulating operations of the CD 102. The UI 204 can further include a display 210 such as monochrome or color LCD (Liquid Crystal Display) for conveying images to the end user of the CD 102, and an audio system 212 that utilizes common audio technology for conveying and intercepting audible signals of the end user.

The power supply 214 can utilize common power management technologies such as replaceable batteries, supply regulation technologies, and charging system technologies for supplying energy to the components of the CD 102 and to facilitate portable applications. The controller 206 can utilize computing technologies such as a microprocessor and/or digital signal processor (DSP) with associated storage memory such a Flash, ROM, RAM, SRAM, DRAM or other like technologies for controlling operations of the CD 102.

It would be evident to an artisan with ordinary skill in the art that the abovementioned components of the CD 102 can be modified or enhanced to meet the needs of an end user without departing from the scope of the present disclosure.

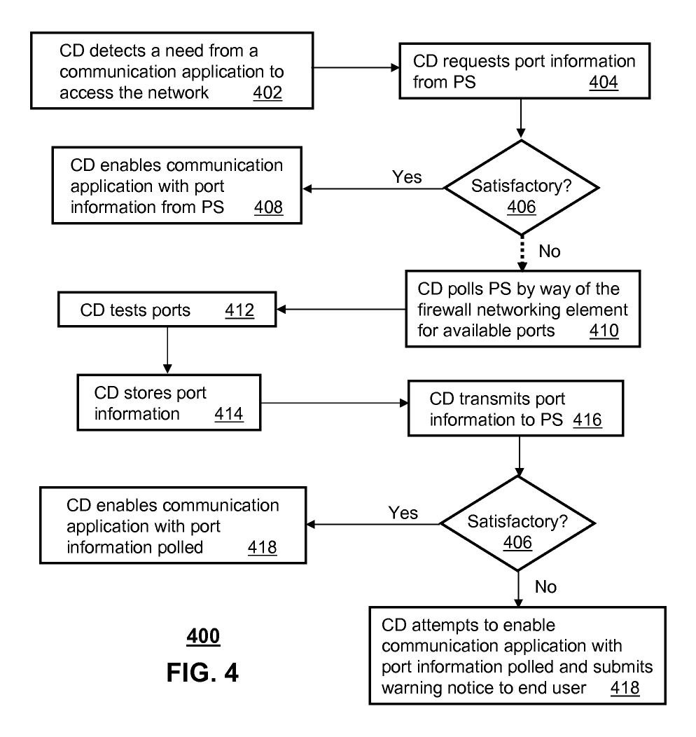

FIG. 3 depicts an exemplary method 300 operating in the CD 102 and a PS 106. Method 300 begins with step 302 in which the PS 106 retrieves port information from one or more FNEs 104. The FNEs 104 can be programmed to provide port information to the PS 106 over a secure link such as a secure sockets layer (SSL). This information can be pushed by the FNEs 104 to the PS 106 independently, or retrieved by the PS 106 from the FNEs 104 periodically, or when needed.

In step 304, the CD 102 detects a request from a communication application requesting access to the communication network 105. The communication application can be, for example, a video application conforming to the H.323 protocol. H.323 is an ITU (International Telecommunications Union) standard for videoconferencing over local area networks and packet-switched networks generally. It is based on a real-time protocol which is commonly used for video over the Internet to ensure that users can communicate with each other, as long as they are using videoconferencing software which complies with the standard. Examples, of applications utilizing this protocol include Microsoft NetMeeting™, and Netscape Conference™. The standard applies both to one-to-one and multi-party videoconferences.

Alternatively, the communication application can be represented by a voice over IP (VoIP) application that establishes communications with a third party by way of the session initiation protocol (SIP) standard. SIP is an Internet Engineering Task Force (IETF) standard protocol for initiating an interactive user session with a real-time protocol (RTP) that involves multimedia elements such as video, voice, chat, gaming, and virtual reality. SIP works in the Application layer of the OSI communications model. RTP is designed to provide end-to-end network transport functions for applications transmitting real-time data. RTP provides such services as payload type identification, sequence numbering, time stamping, and delivery monitoring to real-time applications.

In yet another embodiment, the communication application can be represented by Microsoft's Internet Explorer™ for performing Internet web browsing. There are innumerable applications that can require access to the communication network 105. These and the aforementioned embodiments are within the scope of the operations described by method 300.

Upon detecting any one of these communication applications in step 304, the CD 102 establishes in step 306 an SSL link with the PS 106, and transmits in step 308 to the PS a request for port availability information corresponding to a specific FNE 104. In response the PS 106 selects and transmits to the CD 102 in step 310 the port information corresponding to the requested FNE 104. The port information can be a port or range of ports for a specific type of communication. For example, in the case of SIP, the port number given can range from 5060-5061 with a range of corresponding voice ports ranging between 1024-65,536. For H.323 communications, the ports can range between 1718-1720 with a range of corresponding video ports ranging between 1024-65,536. For World Wide Web access port 80 is generally used. As an alternative embodiment, the CD 102 can establish communication with the PS 106 continuously in which case the CD 102 can remain informed of the availability of ports on a select number of FNEs 104 without having to wait to be prompted by a communication application.

In step 312, the CD 102 can be programmed to determine whether the port information provided by the PS 106 conforms to the needs of the communication application. For instance, a VoIP application may not have access to a data channel through ports 1024-65,536. The FNE 104 may, for example, provide only access through port 80. Under these circumstances, the CD 102 can be programmed in steps 318-320 to change the port assignment of the communication application to a port selected from the port information and enable the communication application with said assignment. The communication application can thereby attempt to transmit voice traffic over port 80 as long as the FNE 104 does not perform deep packet inspections that may otherwise prompt the FNE 104 to preempt said communication due to a policy violation detected by the FNE.

In yet another embodiment, the CD 102 can be programmed in step 322 to establish communications with another CD 102 by way of the PS 106. The PS 106 can be further programmed in step 324 to replace an IP address of the CD 102 with a public IP address prior to communicating with said third party CD. The foregoing step can conform to a Network Address Translation (NAT) protocol for translating an IP address used within one network to a different IP address known within another network.

Referring back to step 312, if the port or ports supplied by the PS 106 conforms to the communication application, the CD 102 can be programmed to process said port information according to alternate embodiments. In a first embodiment, the CD 102 can be programmed to supply the port information to the communication application in step 314. In step 316, the CD 102 enables the communication application to select one or more of the ports supplied under its control. This step overcomes the deficiency in prior art systems that randomly select a port which may be blocked by the FNE 104.

Alternatively, the CD 102 can be programmed in step 326 to communicate the port information to the end user of the CD by way of the UI 204. In this embodiment, the end user can supply in step 328 a selection of a port from the port information by manipulations of the UI 204. Once the selection is made, the CD 102 enables in step 322 the communication application utilizing the port selected in step 328.

FIG. 4 provides an alternative method 400 operating in the CD 102 and the PS 106. In this embodiment, method 400 begins with step 402 in which the CD 102 detects a need from a communication application operating therein to access the communication network 105. In step 404, the CD 102 can be programmed to request port information from the PS 106. The process for requesting port information can follow the aforementioned steps discussed in method 300. If the port information received from the PS 106 is satisfactory in step 406, the CD 102 proceeds to step 408 where it enables the communication application according to said port information. The port information may or not be satisfactory depending on the port needs of the requesting communication application. For example, if the communication application needs port 5060 for a SIP session and only port 80 is available, then the CD 102 will proceed to step 410 to search for alternatives.

In step 410, the CD 102 polls a communications device (such as, for example, the PS 106) by way of the firewall networking element 104 to determine which ports the firewall networking element has made available for communication in the communication system 100. Port availability can be determined by testing ports in step 412 with the PS 106. The testing step can be performed with common software to determine if the port is functioning properly. For example, the CD 102 can be programmed to perform a loop back test or send test packets back and forth between the CD 102 and the PS 106. In step 414, the CD 102 stores the port information polled in its memory and transmits a copy of the polled information to the PS 106 in step 416. If the port information is satisfactory (i.e., it conforms to the needs of the communication application), the CD 102 proceeds to step 418 where it enables the communication application with one or more ports identified in the port information. Otherwise, the CD 102 proceeds to step 418 where it attempts to enable the communication application with the one or more available ports (e.g., attempting a SIP session over port 80) and warns the end user of the lack of ports available for the application and how the foregoing attempt may result in a lower quality of communications.

Alternatively, method 400 can be modified so that the CD 102 periodically polls the PS 106 (or other device) by way of the firewall networking element 104 in anticipation of the potential needs of several communication applications operating in the CD 102. In this embodiment, the CD 102 can be programmed to operate without the need of a PS 106, or can collaborate with the PS 106 when desired.

It would be evident to an artisan with ordinary skill in the art that the aforementioned embodiments can be modified, reduced, or enhanced without departing from the scope and spirit of the claims described below. For example, the CD 102 can be programmed to periodically identify in a memory of the controller 206 a list of available ports which the communication application can review prior to initiating communications without prompting action from the CD 102. The PS 102 can be programmed to periodically transmit port information updates to one or more CDs 102 without being prompted by said CDs. The PS 102 can also be programmed to poll one or more CDs 102 (or other communication devices) operating in the Intranet 103 protected by the firewall networking element 104 to determine which ports the firewall networking element has made available without directly contacting the firewall networking element for said information. Such examples can lead to numerous modifications that read on the claims. Accordingly, the reader is directed to the claims below for a fuller understanding of the breadth and scope of the present disclosure.

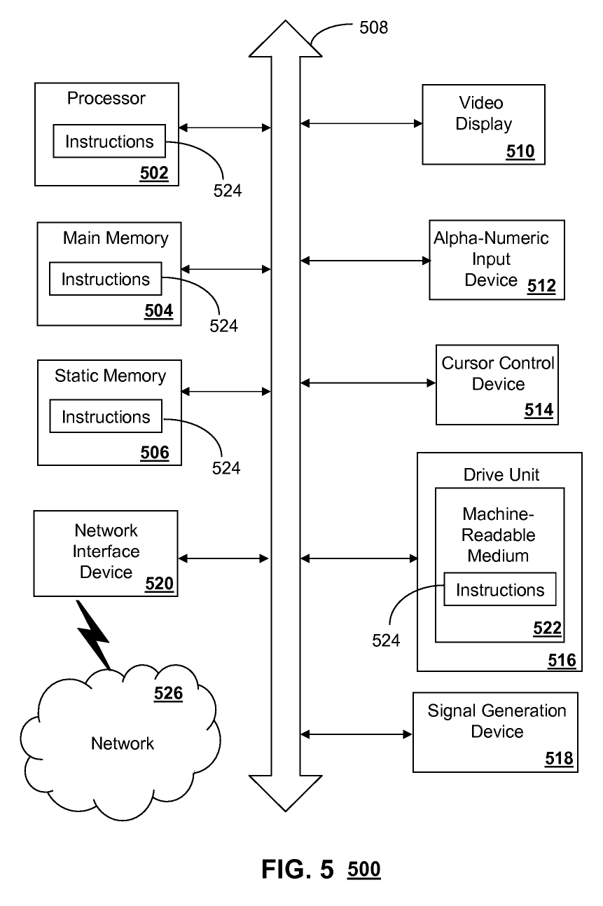

FIG. 5 depicts an exemplary diagrammatic representation of a machine in the form of a computer system 500 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 500 may include a processor 502 (e.g., a central processing unit (CPU), a graphics processing unit (GPU, or both), a main memory 504 and a static memory 506, which communicate with each other via a bus 508. The computer system 500 may further include a video display unit 510 (e.g., a liquid crystal display (LCD), a flat panel, a solid state display, or a cathode ray tube (CRT)). The computer system 500 may include an input device 512 (e.g., a keyboard), a cursor control device 514 (e.g., a mouse), a disk drive unit 516, a signal generation device 518 (e.g., a speaker or remote control) and a network interface device 520.

The disk drive unit 516 may include a machine-readable medium 522 on which is stored one or more sets of instructions (e.g., software 524) embodying any one or more of the methodologies or functions described herein, including those methods illustrated above. The instructions 524 may also reside, completely or at least partially, within the main memory 504, the static memory 506, and/or within the processor 502 during execution thereof by the computer system 500. The main memory 504 and the processor 502 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 524, or that which receives and executes instructions 524 from a propagated signal so that a device connected to a network environment 526 can send or receive voice, video or data, and to communicate over the network 526 using the instructions 524. The instructions 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium in a computing device coupled to a firewall networking element that manages message exchanges with a communication system, comprising computer instructions for:
transmitting to a port server a request for port availability information corresponding to the firewall networking element;
receiving port information from the port server corresponding to the firewall networking element; and
enabling a communication application according to the port information supplied by the port server.

2. The storage medium of claim 1, comprising computer instructions for detecting the communication application requiring port access to the communication system in conformance with the Internet protocol.

3. The storage medium of claim 1, comprising computer instructions for communicating the port information to an end user of the computing device.

4. The storage medium of claim 2, comprising computer instructions for receiving a port selection from the portion information from the end user.

5. The storage medium of claim 4, comprising computer instructions for enabling the communication application according to the port selection.

6. The storage medium of claim 1, comprising computer instructions for detecting no ports in the port information that comply with one or more ports assigned to the communication application.

7. The storage medium of claim 6, comprising computer instructions for:
changing the port assigned to the communication application to a port selected from the port information; and
enabling the communication application according to the changed port assignment.

8. The storage medium of claim 1, comprising computer instructions for configuring the communication application with an IP address of the port server and a port selected from the port information for establishing communications by way of the port server with a third party computing device.

9. The storage medium of claim 1, comprising computer instructions for establishing a secure communications link with the port server.

10. A computer-readable storage medium in a port server coupled to one or more firewall networking elements by way of a communication system, comprising computer instructions for:
receiving port availability information from each of the one or more firewall networking elements;
receiving from a computing device a request for port information corresponding to a select one of the one or more firewall networking elements; and
retrieving the port information requested from the port availability information corresponding to the selected firewall networking element.

11. The storage medium of claim 10, wherein the computing device enables a communication application operating therein according to the port information supplied by the port server, and wherein the storage medium comprises computer instructions transmitting to the computing device the port information.

12. The storage medium of claim 10, comprising computer instructions for establishing a secure communications link with the computing device.

13. The storage medium of claim 10, comprising computer instructions for receiving the port availability information in response to a request transmitted to the one or more firewall networking elements.

14. The storage medium of claim 10, comprising computer instructions for enabling communications between the computing device and a third party computing device by way of the port server, wherein the computing device configures a communication application operating therein with an IP address of the port server and a port selected from the port information.

15. The storage medium of claim 14, comprising computer instructions for replacing an address included in a message directed to the third party computing device with another address.

16. The storage medium of claim 15, wherein the replacing step conforms to a network address translation (NAT) protocol.

17. A communication device comprising a controller that manages a transceiver coupled to a firewall networking element, wherein the controller enables a communication application operating therein according to port information supplied by a port server having port availability information corresponding to the firewall networking element.

18. The communication device of claim 17, wherein the controller:
communicates the port information to an end user by way of a user interface;
receives a port selection from the portion information from the end user; and
enables the communication application according to the port selection.

19. The communication device of claim 17, wherein the controller:
detects no ports in the port information that comply with one or more ports assigned to the communication application;
changes the port assigned to the communication application to a port selected from the port information in response to the lack of ports; and
enables the communication application according to the changed port assignment.

20. The communication device of claim 17, wherein the controller configures the communication application with an IP address of the port server and a port selected from the port information for establishing communications by way of the port server with a third party computing device.

21. A computer-readable storage medium in a computing device coupled to a firewall networking element that manages message exchanges with a communication system, comprising computer instructions for:
polling a communications device by way of the firewall networking element to determine which ports are available for communication in the communication system;
storing port availability information determined from polling the communications device;
detecting a communication application requiring one or more ports to communicate with another computing device in the communication system; and
enabling the communication application according to the port availability information.

22. The storage medium of claim 21, comprising computer instructions for randomly polling for port information by way of the firewall networking element.

23. The storage medium of claim 21, comprising computer instructions for testing each port polled for its availability.

24. The storage medium of claim 21, comprising computer instructions for transmitting the polling availability information to a port server.

25. The storage medium of claim 21, wherein the communications device comprises a port server, and wherein the storage medium comprises computer instructions for:
transmitting to the port server prior to the polling step a request for port availability information associated with the firewall networking element;
receiving port information from the port server associated with the firewall networking element;
polling the port server by way of the firewall networking element to determine which ports are available for communication in the communication system in response to unsatisfactory port information received from the port server; and
enabling the communication application according to the port information supplied by the port server in response to receiving satisfactory port information from the port server.

26. The storage medium of claim 21, comprising computer instructions for notifying an end user of the computing device in response to receiving unsatisfactory port information.
